(19) United States
(12) Patent Application Publication
(10) Pub. No.: US 2008/0107080 A1
(43) Pub. Date: May 8, 2008

(54) SYSTEM AND METHOD OF FAST CHANNEL SCANNING AND IP ADDRESS ACQUISITION FOR FAST HANDOFF IN IP NETWORKS

(76) Inventor: Wei K. Tsai, Irvine, CA (US)

Correspondence Address: FRANK F. TIAN, 331-4A THIRD AVENUE, LONG BEACH, NJ, 07740, US

(21) Appl. No.: 11/870,788

(22) Filed: Oct. 11, 2007

Related U.S. Application Data
(60) Provisional application No. 60/850,649, filed on Oct. 11, 2006.

(51) Int. Cl. H04Q 7/00

(52) U.S. Cl. 370/331

(57) ABSTRACT

A communication system is provided. The system comprises: a set of access points (APs) under tracking; and a table comprising a set of pairs comprising AP_ID, and channel frequency. The channel frequency is associated with an AP among the set of APs identified by AP_ID and the AP is tracked. The set of APs is in a physical neighborhood proximate to a mobile terminal. The mobile terminal is equipped with means to scan channels to discover a specific AP with the best signal quality for communicating between the mobile terminal and the specific AP.

### REFERENCE TO RELATED APPLICATIONS

This application claims an invention which was disclosed in Provisional Application No. 60/850,649, filed Oct. 11, 2006 entitled “SYSTEM AND METHOD OF FAST CHANNEL SCANNING AND IP ADDRESS ACQUISITION FOR FAST HANDOFF IN IP NETWORKS”. The benefit under 35 USC § 119(e) of the United States provisional application is hereby claimed, and the aforementioned application is hereby incorporated herein by reference.

### FIELD OF THE INVENTION

The present invention generally relates to a system and method of fast handoff of a mobile host between two adjacent IP (Internet Protocol) domains, and more particular to a system and method to accomplish two tasks in the fast handoff process: channel scanning and IP address acquisition.

### BACKGROUND OF THE INVENTION

The background of the present invention concerns with a process commonly called as fast handoff of a mobile host between two IP networks. While fast handoff can be defined over a generic setting, the most common setting is that of wireless LANs (local area networks). In particular, the most popular wireless LAN (WLAN) technologies are based on the 802.11 sets of standards, often denoted by 802.11x networks, and referred to as WiFi networks. Currently, the most common examples of 802.11x networks are 802.11a/b/g networks.

While 802.11x networks can be organized in ad hoc mode or infrastructure mode; the current invention concerns handoffs in infrastructure mode networks.

As a mobile host moves from one WLAN to another WLAN, the process of handoff enables a seamless connection for the applications running on the mobile host, often referred to as a mobile terminal.

The process of handoff is often comprised of three major phases: (1) discovery phase, (2) authentication phase, and (3) re-association phase. The purpose of discovery phase is to scan the available wireless channels to discover if a handoff is needed and if it is needed, which channel (corresponding to a new WLAN) to associate. The purpose of authentication is to allow the mobile terminal to be authorized for the association. The final phase is one that enables the mobile terminal to disassociate the old WLAN and re-associate it with the new WLAN.

The present invention comprises two parts. The first part is specifically related to the discovery phase where a scanning algorithm is conducted by the mobile terminal to monitor the wireless channel for potential handoff. The second part is specifically related to the sub-process of acquisition of new IP address in the re-association phase.

Existing measurements show that all three phases in the handoff process could consume considerable amount of time. For real-time applications such as VoIP (voice over IP), a handoff latency over 250-300 milliseconds is not acceptable; hence numerous proposed solutions have appeared in attempt to effect fast handoff. The current invention relates specifically to the first phase of discovery and the third phase of re-association.

In an infrastructure mode WLAN, the LAN is often referred to as a cell or a subnet. In a cell or subnet, there exists a special central controller called the access point (AP). The AP acts as the bridge between the wired and wireless world.

In WiFi networks, there is a mechanism to measure the RF (radio frequency) energy. The numeric value of measured signal quality is often called the Received Signal Strength Indicator (RSSI). Each WiFi cell is associated with a particular channel (or frequency), and the RSSI values are used to compare the signal qualities between different channels and often the most important factor in determining whether a handoff is needed or not.

In the discovery phase, two kinds of scans are provided in the standards: active and passive. The channel-scanning portion of the present invention is suited for both active and passive scans.

In the re-association phase, the mobile terminal, upon joining a new WiFi cell, which is a private IP domain, needs a new IP address. This new IP address must not be used by another device in the same cell; the process of finding the available IP address and assigning the address to the newly arrived mobile terminal is called IP address acquisition and the process of ensuring one IP address is at most used by one device in the same cell is often called duplicate address detection (DAD). The IP address acquisition process is currently done by the DHCP (Dynamic Host Configuration Protocol) via a DHCP server.

Comparing against the passive channel scan methods, the present invention is distinguished by the capability to forecast directionally the AP most likely to be approached by the mobile terminal. The most famous passive channel scan is that of Ishwar Ramani and Stefan Savage (UCSD), where the scheme uses synchronization with the beacon frames sent by the AP. The UCSD scheme can be considered as a time dimension approach whereby the beacon frames are used as timing signals to initiate scanning. In contrast, the present invention is called directional space-time tracking (DST-track) and does not use beacons for timing the scans; DST-track uses only space information.

There exist a few methods that exploit the space dimension in fast handoff. One such example is that of Shin, Forte, Rawat and Schulzinne (CU or Columbia University). The CU scheme uses selective scan (a scheme that does not scan all possible channels for each scan) and records the scan results in the “AP cache” for future use. In a related CU scheme, each AP records the neighboring AP's information in the “neighbor graph” data structure. Then an AP can inform mobile terminals about which channels have neighboring APs, thus reducing the number of channels to be scanned. The CU schemes represent a class of space-dimension scan methods. The present invention is distinguished by being the first one to adaptively learn about the space distribution of APs and track the movement of the mobile terminal in the space in relation to the surrounding APs.

Comparing the IP address acquisition part (called SID or simple IP discovery) of the present invention against other fast handoff schemes, the main difference is that the present invention (SID architecture) is a method that does not require modification to the DHCP server. In the scheme called P-DAD by the Columbia University (Shin, Forete and Schulzinne), an agent called CAU (address usage collector) is needed to sit in the data path of the entire WLAN. The DHCP must modified in this P-DAD scheme because the agent CAU must communicate with the DHCP server while CAU is not a host, and a new protocol is needed to enable communications between CAU and the DHCP server. The SID architecture is a system that requires modification of the mobile terminal and no modification of the DHCP server. In contrast, the P-DAD scheme requires modification in the DHCP server, but no modification in the mobile terminal.

### SUMMARY OF THE INVENTION

It is, therefore, an object of the present invention to provide a system and method to minimize handoff time for a mobile host to move from one IP domain to another by minimizing the time needed for discovery of new AP to associate and the time needed to acquire a new IP address in the new IP domain.

It is another object of the present invention to provide a system and method to forecast a possible handoff and the most likely subnet, along with the associated AP, for the mobile terminal.

It is another object of the present invention to provide a system and method for a mobile terminal to acquire an available IP address in the newly arrived subnet within one round trip time between the mobile terminal and the subnet.

It is another object of the present invention to provide a system and method for accomplish fast handoff without modifying the AP while minimally or non-disruptively modifying the mobile terminals.

In accordance with a preferred embodiment of the present invention, a scheme called DST-track (directional space-time tracking) is used to track possible APs (with their associated channel numbers or RF frequencies) for the discovery phase of the fast handoff process in WiFi networks.

In accordance with a preferred embodiment of the present invention, a scheme called SID (simple IP discovery) is used to enable mobile terminals to communicate directly with a device called SID server and within one RTT time (the round trip time between a mobile terminal to the associated AP and back) to obtain an unused IP address in the subnet available for the mobile terminal.

In accordance with a preferred embodiment of the present invention, the system and method requires modification on the mobile terminals without modification on the APs and DHCP servers.

In accordance with a preferred embodiment of the present invention, the DST-track system is, for each mobile terminal, capable of discovering neighboring APs within an RF-reachable (defined below) range and forecasting the most likely APs to associate in the near future.

In accordance with a preferred embodiment of the present invention, for each subnet, the SID server can be implemented in the AP or outside the AP via a box with either a wired or wirelessly connection to the subnet.

In accordance with a preferred embodiment of the present invention, the SID system of IP address acquisition is non-disruptive in the sense that for those mobile terminal that does not require fast handoff (such as best effort Web terminals) does not have to be modified to use SID; they can still use DHCP for IP address acquisition.

In accordance with a preferred embodiment of the present invention, SID is also used to find out all the IP parameters needed to connect to an IP network (e.g. default gateway, subnet mask, DNS server, etc.).

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows trade-off based on number of APs being tracked.

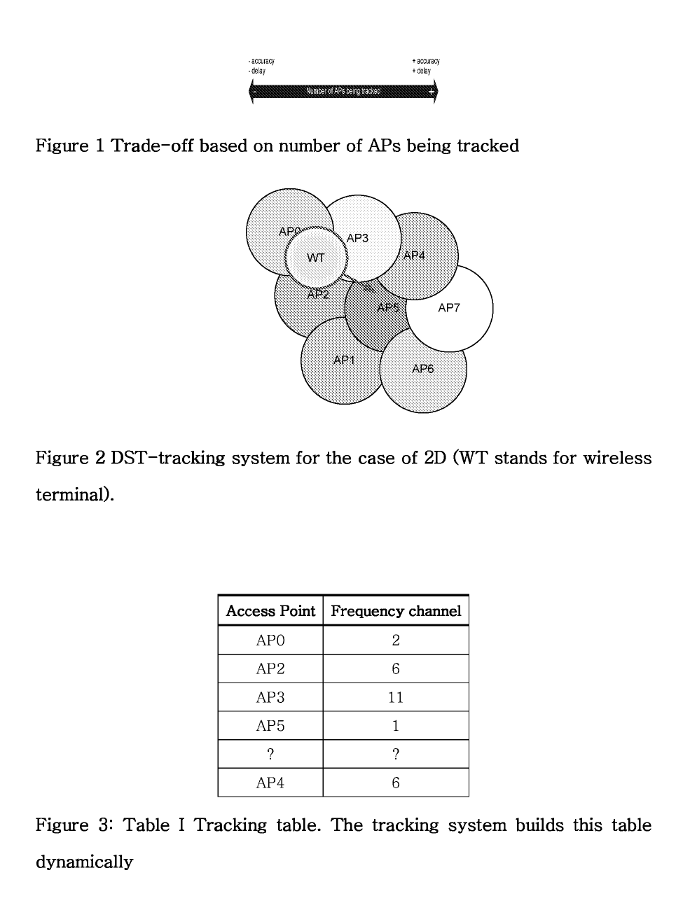

FIG. 2 illustrates DST-tracking system for the case of 2D; WT in the diagram represents a mobile terminal.

FIG. 3 shows tracking table. The tracking system builds this table dynamically.

FIG. 4 illustrates Example of a partial representation of the environment. The tracking system dynamically learns the topology of the environment, building an internal map that will permit spatial tracking.

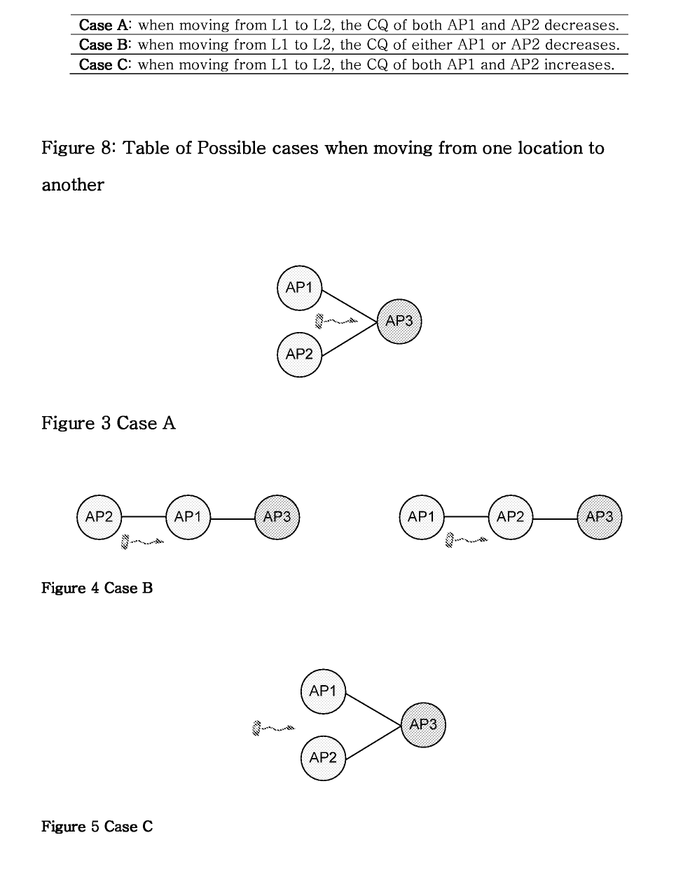

FIG. 5 shows typical operations carried by a DHCP server to find out an available IP address.

FIG. 6 illustrates the SID architecture.

FIG. 7 illustrates call flows for (left) proactive SID server operation and for (right) the process of acquiring an IP address by a SID client.

### DETAILED DESCRIPTION OF THE PRESENT INVENTION

Certain embodiments as disclosed herein provide for a MAC module that is configured to be deployed in a wireless communication device to facilitate multi-hop wireless network communications over high bandwidth wireless communication channels based on UWB, OFDM, 802.11/a/b/g, among others. In one embodiment, the nodes involved in the multi-hop wireless communications are arranged in a mesh network topology. For example, one method as disclosed herein allows for the MAC module to determine the network topology by parsing beacon signals received from neighbor nodes within communication range and establish high bandwidth communication links with those nodes that are within range to provide a signal quality that supports high bandwidth communication. For applications that require a certain level of quality of service, the methods herein provide for establishing a multi-hop end-to-end route over the mesh network where each link in the route provides the necessary level of signal quality.

After reading this description it will become apparent to one skilled in the art how to implement the invention in various alternative embodiments and alternative applications. To facilitate a direct explanation of the invention, the present description will focus on an embodiment where communication is carried out over a UWB network, although the invention may be applied in alternative networks including 802.11, 802.15, 802.16, worldwide interoperability for microwave access (“WiMAX”) network, wireless fidelity (“WiFi”) network, wireless cellular network (e.g., wireless wide area network (“WAN”), Piconet, ZigBee, IUP multimedia subsystem (“IMS”), unlicensed module access (“UMA”), generic access network (“GAN”), and/or any other wireless communication network topology or protocol. Additionally, the described embodiment will also focus on a single radio embodiment although multi-radio embodiments and other multiple input multiple output (“MIMO”) embodiments are certainly contemplated by the broad scope of the present invention. Therefore, it should be understood that the embodiment described herein is presented by way of example only, and not limitation. As such, this detailed description should not be construed to limit the scope or breadth of the present invention as set forth in the appended claims.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

In the present invention, the basic approach for AP discovery is based on selective scanning: only a subset of all possible frequencies (each frequency is associated with a possible neighboring AP) is selected for scanning at each scanning period.

In the present invention, according to the DST (directional space-time) tracking method, the set of tracked APs for each mobile terminal is chosen according to reachability of APs from the mobile terminal over a minimal RF signal quality. Furthermore, those APs fall outside of the reachable range are dropped and those that enter into reachable range are added after they have been discovered in a scanning period.

In accordance with a preferred embodiment of the present invention, there is a trade-off between the number of tracked APs and the accuracy of tracking system: the more APs are being tracked, the more accurate is the tracking system but the longer it takes to scan completely the tracked APs, and vice versa. The accuracy of the tracking system is determined by the minimal signal quality, often in the form of minimal RSSI for the WiFi networks.

In accordance with a preferred embodiment of the present invention, the movement of a mobile terminal can be topologically determined in relation to its neighboring APs.

Suppose that APs are linearly independent (it is said that APs are linearly independent if one AP is never located in the straight line connecting any other 2 APs). Then:
(1) If APs are located in a 2D-plane (e.g., one floor building), then to know the mobile terminal XY location it is enough to track 3 APs.
(2) If APs are located in a 3D-space (e.g., multiple floor building), then to know the mobile terminal XYZ location it is enough to track 4 APs.

In accordance with a preferred embodiment of the present invention, each mobile terminal is associated with a candle zone, which is defined as the sphere (for 3-D tracking) or circle (for 2-D tracking) centered with the mobile terminal with a radius defined by signal reachability (based on a predefined signal to noise ratio threshold).

In accordance with a preferred embodiment of the present invention, tracked APs are added or dropped according to the concept of space tracking: only those APs that are inside the candle zone are tracked. Furthermore, the embodiment can also track the direction of the associated mobile terminal by means of signal quality: if the mobile terminal is moving away from one AP, the corresponding RF SNR (signal to noise ratio) tends to drop; if the mobile terminal is moving toward an AP, the corresponding RF SNR tends to rise.

In accordance with a preferred embodiment of the present invention, a tracking table is created for each mobile terminal. The table contains the pairs (AP identity, channel frequency) for tracked APs. Once the criterion for handoff is met, the next AP selected for association will be chosen based on multiple options. In one option, the AP with the best SNR is chosen, while in the other option, the AP with second best SNR with increasing SNR from previous scanning. This is scenario is very interesting in real-life as it is possible that the mobile terminal may be moving away from a AP with the best SNR while it is also moving towards the AP with the second best SNR.

In accordance with a preferred embodiment of the present invention, APs within the tracking table (or equivalently the candle zone) are periodically scanned for signal quality. The time instants selected for scanning for the present invention are not synchronized with beacons from the neighboring APs. The set of APs to be scanned will be a selective subset of the entire tracking table; the criteria used for selection is a design parameter which is not specified in the present invention.

In accordance with a preferred embodiment of the present invention, APs (in the form of channel frequencies) outside the tracking table are periodically scanned for signal quality. The time instants selected for scanning for the present invention are not synchronized with beacons from the neighboring APs. The set of frequencies to be scanned will be a selective subset of the entire spectrum of available frequencies; the criteria used for selection is a design parameter which is not specified in the present invention.

In accordance with a preferred embodiment of the present invention, the AP tracking system is capable of forecasting the AP (or equivalently the subnet) the mobile terminal is moving towards. Such a system is called directional tracking as it indicates not only position but also direction of movement.

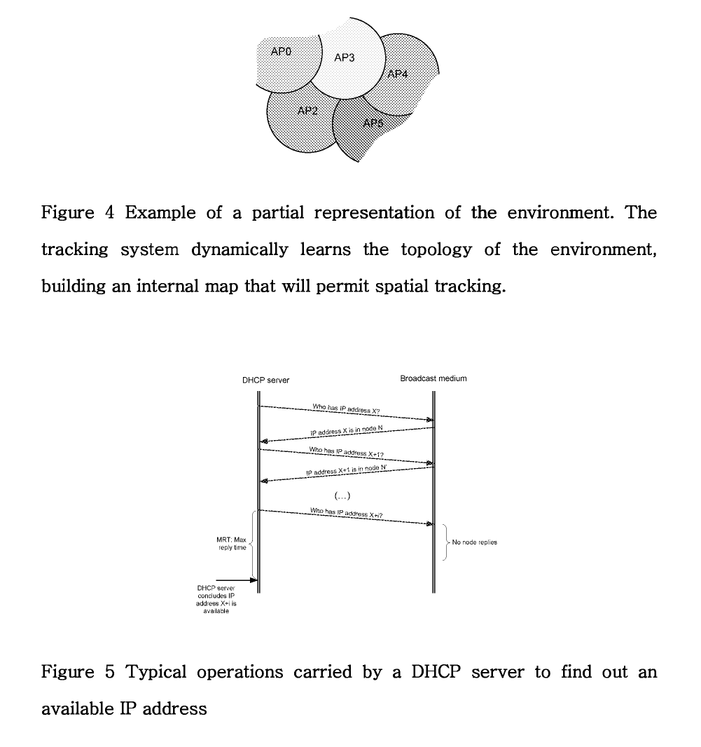

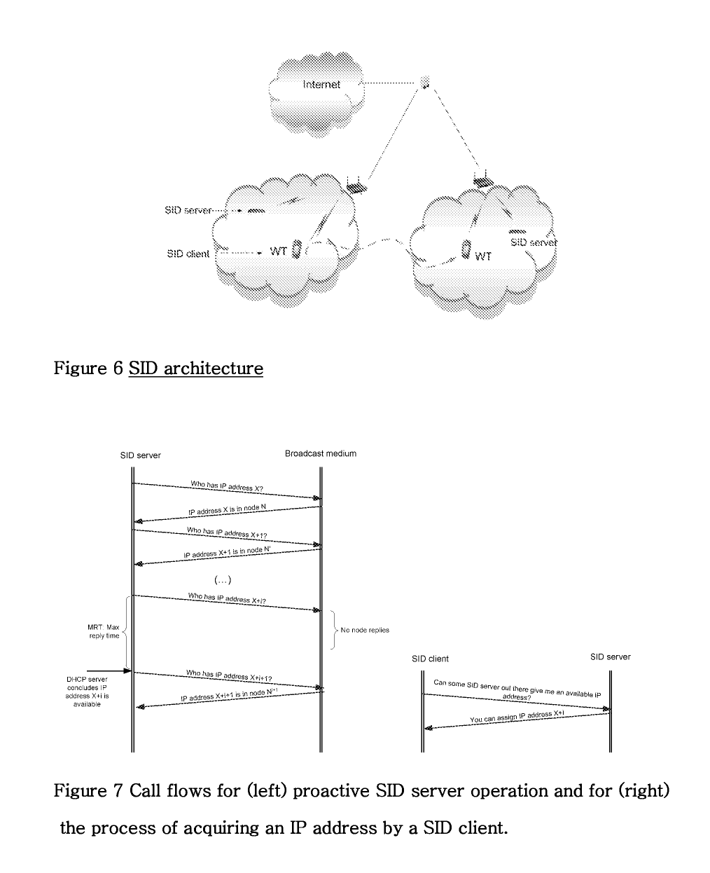

In accordance with a preferred embodiment of the present invention, the concept of directional tracking is best explained via an example. Consider FIG. 2 where the mobile terminal is represented by the symbol (WT). From the history of space-time tracking, the SNR of AP0 fades, while the SRN for AP2 and AP3 stay constant. The DST tracking system will conclude that the mobile terminal is approaching AP5. From the current tracking table (FIG. 3) and it is found that AP5 is using frequency channel 1. Then, after some threshold values are met, the DST system will stop tracking frequency 2, and start tracking frequency 1.

In accordance with a preferred embodiment of the present invention, the space-time tracking system can be used to create a topological map surrounding the mobile terminal. The topological map is created by repeated application of the candle zone algorithm; the overall process is called the self-learning topology construction algorithm. The constructed topology will be useful in forecasting which AP will be the next one to associate once the movement of the mobile terminal on the topological map is determined.

The following presents an algorithm to reconstruct the topology of a network of access points. The algorithm is applicable in all networks that satisfy the following assumption: that the terminal has a mechanism by which it can periodically scan the presence of access points and provide a measurement of the communication quality (CQ) to each of these access points. Here the term CQ is understood as a generic parameter indicating the quality of the communication channel between the terminal and the access point, in the sense that a terminal would prefer to communicate with access point AP more than access point AP′ if the CQ of AP were larger than that of AP′. For instance, communication quality can include (but is not limited to) signal to noise ratio, delay, transmission speed, bandwidth, noise, signal strength, etc. In the particular case of mobility, the CQ of one access point will be inversely proportional to the distance between the terminal and the access point. This enables a mechanism by which the terminal can discover the topology of a network of access points, as explained next.

To understand the basic mechanism, suppose that a terminal is constantly tracking the two access points which have the largest CQ. Suppose that at locations L1 and L2 the two APs with largest CQ are AP1 and AP2 for L1, and AP2 and AP3 for L2. Now there are 3 cases as shown in the following table: In case A, we can conclude that the terminal is moving away from AP1 and AP2 while approaching AP3. This is represented in Error! Reference source not found. In case B, we can conclude that the terminal is moving away from either AP1 or AP2 while approaching AP3. This is represented in Error! Reference source not found. case B. In this figure, the left case represents the situation in which AP2 decreases its CQ while the right case represents the situation in which AP1 decreases its CQ. In case C, we can conclude that the terminal is approaching both AP1 and AP2 while at the same approaching AP3. This is represented in Error! Reference source not found. Notice that this case is only possible if the radiation diagram of AP3 is different than that of AP1 and AP2. In particular, case 3 implies that AP3 has a radiation diagram with steeper gradient than that of AP1 and AP2.

Based on the previous observation, it is possible to derive an algorithm to construct the topological map of access points. We refer to this algorithm as the candle light algorithm.

In the second part of the present invention, the problem of IP address acquisition is solved. Currently this problem is solved by the DHCP protocol which works as follows:
(1) A terminal T that needs to acquire an IP address issues a request to a DHCP server DS.
(2) Upon receiving the request, DS searches for an available IP address, that is an IP address that is not being used by any other terminal within the subnet in which T resides.
(3) Once it founds an available IP address IPA, DS sends a DHCP reply to terminal T. This reply message carries IPA in one of its fields.
(4) Upon receiving the DHCP reply, T assigns IPA to its network interface.
   Notice that the time required to complete both steps 1 and 3 is ½ RTT seconds, while the time spent in step 4 is negligible since it is a local operation executed at terminal T. As far as fast handoff is concerned, the major overhead in the above operations resides on step 2.

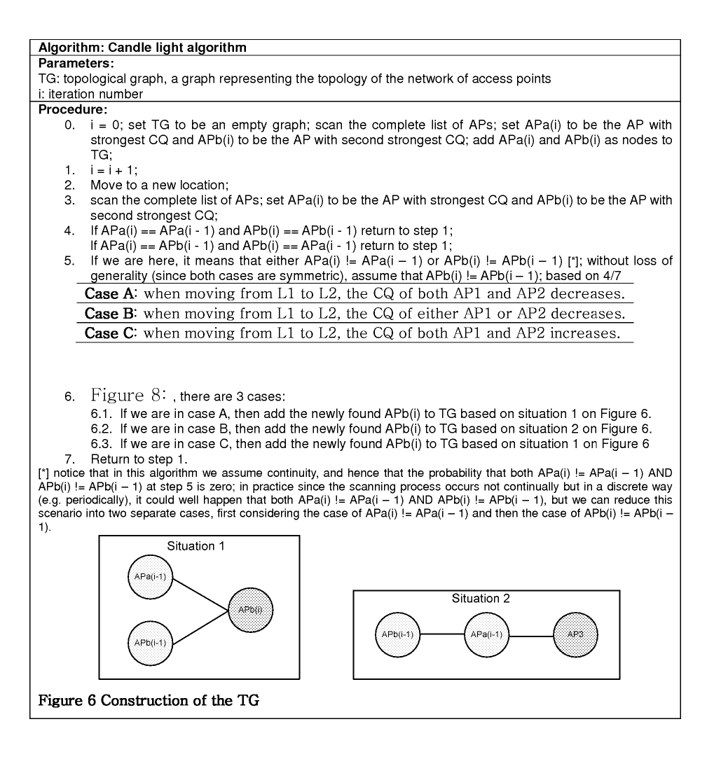

FIG. 5 illustrates the generic structure of the operations carried by the DHCP server in step 2. In general, to discover an available IP address, the server will poll one by one the IP addresses that belong to the subnet in which it resides, broadcasting a message asking whether any terminal in the subnet is using that particular IP address. This process will terminate when for a particular IP address the server receives no reply. Therefore, the total time required to terminate step 2 is:
T₂=(i−1)′RTT+MRT
where i is the number of IP addresses that server has to poll before the server finds one that is available and MRT is the maximum reply time, understood as the maximum time the server will wait for a reply before assuming that no terminal is using the requested IP address. Notice that in practice, MRT is typically set to multiple times of RTT. Furthermore, while not shown in FIG. 5, because the medium can be unreliable (for instance due to the possibility of noise or packet collision) a typical DHCP server will retransmit the request message multiple times before giving up.

Experimental results using commercial DHCP clients show that in practice step 2 can take up to a few seconds. This performance is not tolerable especially for real time application such as VoIP.

In accordance with a preferred embodiment of the present invention, the scheme of SID (simple IP discovery) is used as an alternative to DHCP that will guarantee the acquisition of an available IP address in no more than 1 RTT seconds.

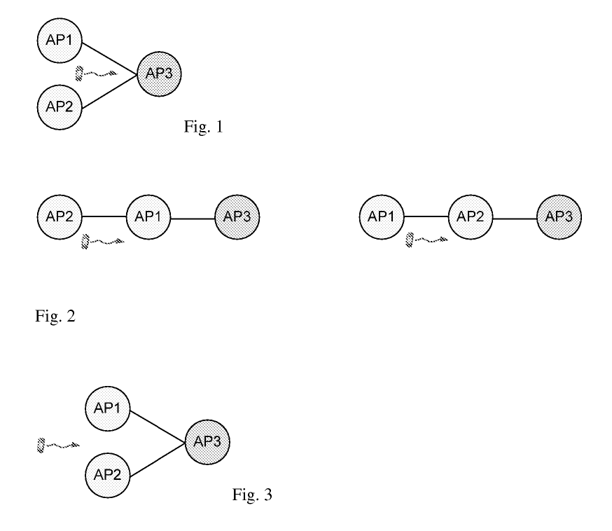

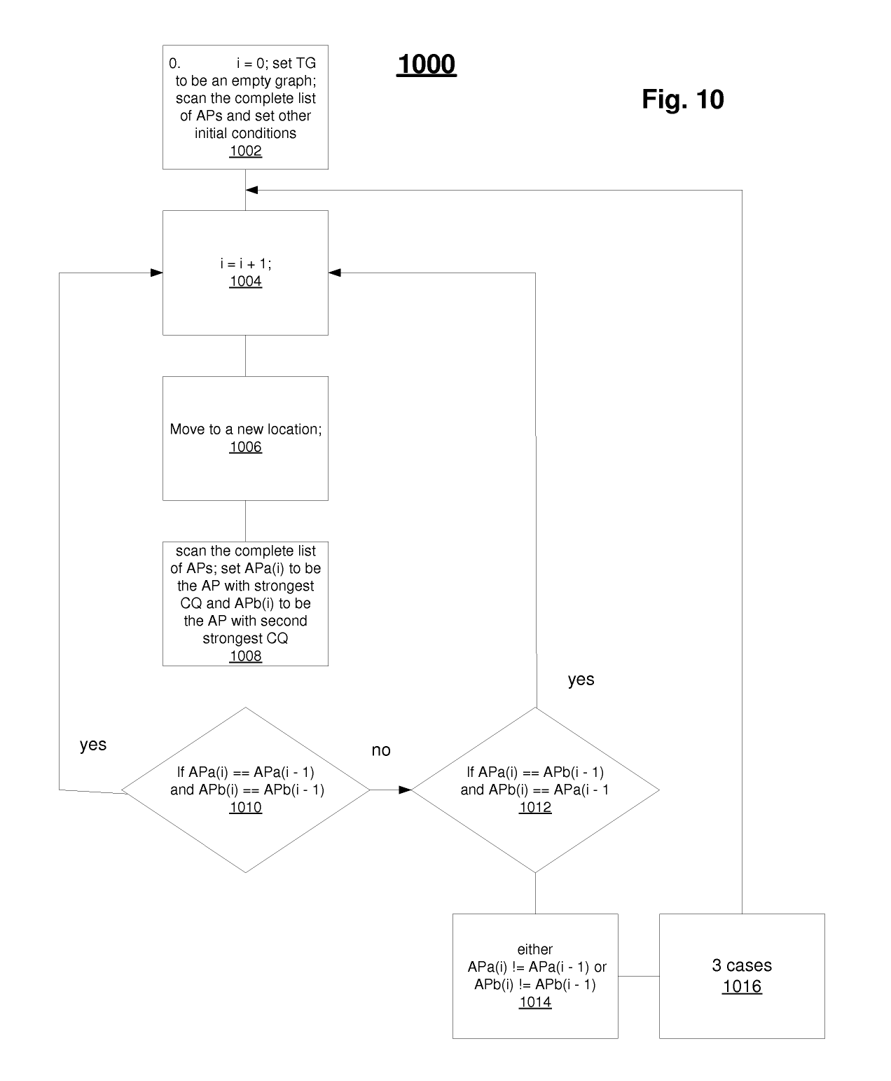

In accordance with a preferred embodiment of the present invention, the SID architecture has two software components: a SID server and a SID client. SID clients run in the wireless terminals while the SID server can run either in the access point or in a separate IP node residing in the subnet it manages. FIG. 6 presents a possible implementation of the SID client/server architecture, in which the SID server is embodied in a separate box. FIG. 7 shows the flow calls corresponding to the SID protocol.

In accordance with a preferred embodiment of the present invention, in the background, the SID server proactively monitors the set of available IP addresses. It does so by scanning the list of IP addresses in the subnet it manages and asking the broadcast medium whether some terminal has that IP address. If no terminal replies a request for a particular IP address, the SID server concludes that it is available. When a terminal needs to assign a new IP address to its interface (for instance because it just moved to a new subnet), instead of invoking a DHCP transaction, for a fast handoff it can use SID. In that case, the terminal would issue a SID request asking for an available IP address within that subnet. Upon receiving the request, the SID server can immediately reply with an available IP address. Notice that this is possible since the SID server constantly monitors the list of available IP addresses in the subnet. Notice also that with this scheme, the total time it takes for a terminal to acquire an available IP address is one RTT.

In accordance with a preferred embodiment of the present invention, the nature of a SID request issued by a SID client is as follows. Because in many circumstances the SID client will not know how to reach the SID server (for instance this can happen when the terminal moves to a foreign subnet whose parameters are apriori not known to it), the SID request message issued by a SID client can take the form of a broadcast message. Only the SID server should process this request according to the procedure above explained.

In accordance with a preferred embodiment of the present invention, the SID scheme is also used as a protocol to assign an available IP address to a terminal, it can also be used to assign all the IP parameters needed to connect to an IP network, e.g. default gateway, subnet mask, DNS server. A possible implementation could keep this information in the SID server. Then the server could piggyback all these additional networking parameters onto the SID replies it sends to the terminals.

In accordance with a preferred embodiment of the present invention, SID is non-disruptive in the sense that it perfectly coexists with DHCP. For instance, a particular subnet can be managed both by a DHCP server and a SID server. Terminals can then choose one service or the other depending on the requirements of the application it is running. An example is that of VoIP mobility; since keeping the end-to-end delay low is crucial in order to guarantee the quality of a voice call, a terminal should use SID when moving from one subnet to another. For less delay critical operations, a terminal can optionally use DHCP.

There is provided a system and method for enabling fast handoff of a mobile host to move from one IP domain to another IP domain by minimizing two components of the handoff: access point discovery and acquisition of unused IP address in the new domain. In the said system and method, the access point discovery is via a directional space-time tracking system where the system forecasts the next access point to associate with the mobile host. The tracking system is self-learning as it is capable of learning the topology of the access point connections in a local region and this topological map is used to help forecast the access point of the IP domain the mobile host is moving into. For IP address acquisition, the said system and method provide a proactive system where a simple server keeps track of a list of available IP addresses for the associated IP domain. The acquisition time for a new IP address is achieved within one RTT time between the mobile terminal and the simple server. The IP address scheme is non-disruptive in the sense that the DHCP server does not have to be modified while a mobile host without a real-time requirement can still use the existing DHCP protocol to acquire an unused IP address. Both methods of access point discovery and IP address acquisition does not require modification of the access points while only the mobile terminals need to be modified.

In accordance with a preferred embodiment of the present invention, SID server and client messages can take any form. One particular form of SID server messages are ARP messages. For instance, a SID server could use an ARP request message to ask the broadcast medium “who has a particular IP address.”

Referring to FIG. 10, a flowchart 1000 of the present invention is shown. a topological graph (TG), a graph representing the topology of the network of access points is created. i:is the iteration number. Initial conditions are set (Step 1002). The setting of initial conditions includes i=0; set TG to be an empty graph; scan the complete list of APs; set APa(i) to be the AP with strongest CQ and APb(i) to be the AP with second strongest CQ; add APa(i) and APb(i) as nodes to TG. “i” is incremented (Step 1004). Move to a new location (Step 1006). scan the complete list of APs; set APa(i) to be the AP with strongest CQ and APb(i) to be the AP with second strongest CQ (Step 1008). If APa(i)==APa(i−1) and APb(i)==APb(i−1) return to step 1004 (Step 1010). If APa(i) APb(i−1) and APb(i) APa(i−1) return to step 1004 (Step 1012). If we are here, it means that either APa(i) !=APa(i−1) or APb(i) !=APb(i−1) [*]; without loss of generality (since both cases are symmetric), assume that APb(i) !=APb(i−1); based on Error! Reference source not found, there are 3 cases (Step 1014).
Case I. If we are in case A, then add the newly found APb(i) to TG based on situation 1 on Error! Reference source not found.
Case II. If we are in case B, then add the newly found APb(i) to TG based on situation 2 on Error! Reference source not found.
Case III. If we are in case C, then add the newly found APb(i) to TG based on situation 1 on Error! Reference source not found.

Return to step 1. (Step 1016). notice that in this algorithm we assume continuity, and hence that the probability that both APa(i) !=APa(i−1) AND APb(i) !=APb(i−1) at step Error! Reference source not found. is zero; in practice since the scanning process occurs not continually but in a discrete way (e.g. periodically), it could well happen that both APa(i) !=APa(i−1) AND APb(i) !=APb(i−1), but we can reduce this scenario into two separate cases, first considering the case of APa(i) !=APa(i−1) and then the case of APb(i) !=APb(i−1).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system comprising:
a set of access points (APs) under tracking; and
a table comprising a set of pairs comprising AP_ID, and channel frequency, wherein the channel frequency is associated with an AP among the set of APs identified by AP_ID and the AP is tracked;
wherein the set of APs is in a physical neighborhood proximate to a mobile terminal and the mobile terminal is equipped with means to scan channels to discover a specific AP with the best signal quality for communicating between the mobile terminal and the specific AP.

2. The system of claim 1 wherein the APs associated with the table are periodically scanned for signal quality, and the APs with signal quality lower than a predetermined threshold are dropped from the table.

3. The system of claim 2 wherein the APs not in the table are periodically scanned for signal quality, the APs with signal quality stronger than a predetermined threshold are added to the table.

4. The system and method of claim 3 wherein an algorithm based on signal qualities is executable from the mobile terminal to construct a topological map showing the interconnections of APs in the neighborhood of the mobile terminal.

5. The system of claim 3 wherein forecasts are performed within the subnet (or the AP of the subnet), wherein the mobile terminal is traversing toward; the forecasts being based on the space-time movement of the mobile terminal as indicated by both the topological map and the changes in the signal qualities.

6. A system comprising:
a SID server;
a DHCP server signally coupled to the SID server, DS;
a mobile terminal associated with the SID server and the DHCP server; and
an IP subnet, wherein the mobile terminal is able to perform direct communication with at least one access point associated with the subnet;
wherein the mobile terminal communicates either with the SID server, or the DHCP server to obtain an unused IP address within the subnet.

7. The system of claim 6 wherein the SID server keeps track of a list of unused IP addresses in the subnet.

8. The system of claim 7 wherein the mobile terminal obtains an unused IP address from the SID server in one RTT time between the mobile terminal and the SID server.

9. The system of claim 8 wherein the mobile terminal is adapted to select an unused IP address within the subnet from the DHCP server.

10. A method comprising:
providing a set of access points (APs) under tracking; and
providing a table comprising a set of pairs comprising AP_ID, and channel frequency, wherein the channel frequency is associated with an AP among the set of APs identified by AP_ID and the AP is tracked;
wherein the set of APs is in a physical neighborhood proximate to a mobile terminal and the mobile terminal is equipped with means to scan channels to discover a specific AP with the best signal quality for communicating between the mobile terminal and the specific AP.

11. The method of claim 10 wherein the APs associated with the table are periodically scanned for signal quality, and the APs with signal quality lower than a predetermined threshold are dropped from the table.

12. The method of claim 11 wherein the APs not in the table are periodically scanned for signal quality, the APs with signal quality stronger than a predetermined threshold are added to the table.

13. The method of claim 12 wherein an algorithm based on signal qualities is executable from the mobile terminal to construct a topological map showing the interconnections of APs in the neighborhood of the mobile terminal.

14. The method of claim 12 wherein forecasts are performed within the subnet (or the AP of the subnet), wherein the mobile terminal is traversing toward; the forecasts being based on the space-time movement of the mobile terminal as indicated by both the topological map and the changes in the signal qualities.
